(19) United States
(12) Patent Application Publication
(10) Pub. No.: US 2023/0044519 A1
(43) Pub. Date: Feb. 9, 2023

(54) FLEXIBLE COVER WINDOW WITH IMPROVED STRENGTH

(71) Applicant: UTI INC., Chungcheongnam-do (KR)

(72) Inventors: Kukhyun SUNWOO, Gyeonggi-do (KR); Tea Joo HA, Chungcheongnam-do (KR); Jae Suk OH, Gyeonggi-do (KR)

(73) Assignee: UTI INC., Chungcheongnam-do (KR)

(21) Appl. No.: 17/816,591

(22) Filed: Aug. 1, 2022

(30) Foreign Application Priority Data
Aug. 4, 2021 (KR) 10-2021-0102768

(51) Int. Cl. C03C 17/32; B05D 3/06

(52) U.S. Cl. CPC C03C 17/32; B05D 3/067; B05D 2203/35; B05D 2701/30; C03C 2217/78

(57) ABSTRACT

Disclosed is a glass-based flexible cover window with improved strength including a planar portion formed so as to correspond to a planar region of a flexible display and a folding portion formed so as to be connected to the planar portion, the folding portion being formed so as to correspond to a folding region of the flexible display, wherein the flexible cover window includes a glass substrate and a polyimide (PI) coating layer formed on the glass substrate. The PI coating layer is formed on the glass substrate by direct coating, whereby inherent texture of glass is maintained while the overall thickness of the flexible cover window is reduced, and therefore aesthetics of the flexible cover window are improved.

### CROSS-REFERENCE TO RELATED APPLICATION

This application claims priority from Korean Patent Application No. 10-2021-0102768, filed on Aug. 4, 2021, in the Korean Intellectual Property Office, the disclosure of which is incorporated herein by reference in its entirety.

### BACKGROUND OF THE INVENTION

### 1. Field of the invention

The present invention relates to a flexible cover window, and more particularly to a flexible cover window with improved strength configured such that strength characteristics of the flexible cover window are improved and inherent texture of glass is maintained while the overall thickness of the flexible cover window is reduced, whereby aesthetics of the flexible cover window are improved.

### 2. Description of the Related Art

With recent rapid development of electric and electronic technologies and an increase in new demands of the times and various demands of consumers, various types of display products have been manufactured. Thereamong, research on a flexible display capable of being folded and unfolded has been actively conducted.

At first, research on folding the flexible display was conducted, and now research on rolling and stretching the flexible display are being conducted. Not only a display panel but also a flexible cover window configured to protect the display panel must be flexible.

Such a flexible cover window must be basically flexible and must have no wrinkles at the folding region thereof after repeated folding, and image distortion must not occur.

For a conventional cover window for flexible displays, a polymer film, such as a PI film or a PET film, is attached to the surface of a display panel.

Since the mechanical strength of the polymer film is low, however, the polymer film serves merely to prevent scratches on the display panel. In addition, the polymer film has low resistance to shock and low transmittance. Furthermore, the polymer film is relatively expensive.

As the number of folds of the display increases, the folding region of the polymer film is wrinkled, whereby the folding region of the polymer film is damaged. For example, the polymer film is pressed or torn at the time of folding limit evaluation (generally 200,000 times).

In recent years, various research on a glass-based cover window has been conducted in order to overcome the limit of the polymer film cover window.

Such a glass-based cover window requires fundamental physical properties. For example, image distortion must not occur, and the glass-based cover window must have sufficient strength with respect to repetitive contact of a touch pen and specific pressure while folding characteristics must be satisfied.

In order to satisfy the strength characteristics of the flexible cover window, glass must have a specific thickness or more. In order to satisfy the folding characteristics of the flexible cover window, on the other hand, the glass must have a specific thickness or less. Consequently, research on the optimum thickness and structure of the flexible cover window at which image distortion does not occur while both the strength characteristics and the folding characteristics are satisfied is necessary.

Also, in the case in which the glass has a specific thickness or less, inherent texture of a reinforced glass is deteriorated, which must also be considered.

Therefore, there is a need for technology capable of providing a flexible cover window having an appropriate thickness necessary to secure strength and at the same time satisfying folding characteristics while maintaining inherent aesthetics of the reinforced glass.

### SUMMARY OF THE INVENTION

The present invention has been made in view of the above problems, and it is an object of the present invention to provide a flexible cover window configured such that a PI coating layer is formed on a glass substrate, whereby strength of the flexible cover window is improved.

In accordance with the present invention, the above and other objects can be accomplished by the provision of a glass-based flexible cover window with improved strength including a planar portion formed so as to correspond to a planar region of a flexible display and a folding portion formed so as to be connected to the planar portion, the folding portion being formed so as to correspond to a folding region of the flexible display, wherein the flexible cover window including a glass substrate and a polyimide (PI) coating layer formed on the glass substrate.

The PI coating layer may be formed on one surface or opposite surfaces of the glass substrate. In addition, the PI coating layer may have a thickness of 1 to 50 μm.

In addition, the PI coating layer may be formed by coating the glass substrate with a coating solution including 100 parts by weight of polyimide (PI) and 2 to 10 parts by weight of primer.

In addition, the PI coating layer may be formed on a front surface, a back surface, and a side surface of the glass substrate so as to wrap the glass substrate.

In addition, the PI coating layer may be formed on the glass substrate by coating and may then be UV-hardened. The PI coating layer may be formed on the glass substrate by any one of bar coating, slot-die coating, and dip coating.

The flexible cover window may further include a functional layer formed on the PI coating layer formed on a front surface of the glass substrate.

The flexible cover window may further include a buffer layer formed between a back surface of the glass substrate and a display panel.

In addition, the PI coating layer may be made of a material configured such that the PI coating layer has an equal strength or different strengths at the planar portion and the folding portion.

Meanwhile, the glass substrate may be integrally formed, may be formed such that the folding portion is slimmer than the planar portion, or may be formed such that the folding portion is divided into two or more pieces.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 6 are schematic views showing various embodiments of a flexible cover window with improved strength according to the present invention.

### DETAILED DESCRIPTION OF THE PREFERRED EMBODIMENTS

The present invention relates to a flexible cover window, and more particularly to a flexible cover window configured such that a PI coating layer is formed on a glass substrate, whereby surface hardness, pen drop characteristics, and folding characteristics of the flexible cover window are improved.

Also, in the flexible cover window according to the present invention, the PI coating layer is formed on the glass substrate by direct coating, whereby inherent texture of glass is maintained while the overall thickness of the flexible cover window is reduced, and therefore aesthetics of the flexible cover window are improved.

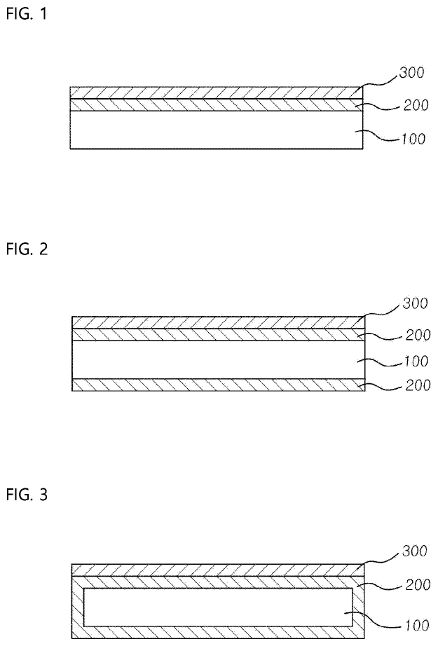

Hereinafter, the present invention will be described in detail with reference to the accompanying drawings. FIGS. 1 to 6 are schematic views showing various embodiments of a flexible cover window with improved strength according to the present invention.

As shown, the flexible cover window with improved strength according to the present invention is a glass-based flexible cover window including a planar portion formed so as to correspond to a planar region of a flexible display and a folding portion formed so as to be connected to the planar portion, the folding portion being formed so as to correspond to a folding region of the flexible display, wherein the flexible cover window includes a glass substrate 100 and a PI coating layer 200 formed on the glass substrate 100.

In the present invention, a front surface means a surface that a user can touch, a surface that a touch pen contacts, and an upper surface in the drawings. Also, in the present invention, a back surface, which is a surface opposite to the front surface, means a surface opposite to the surface that is touched, i.e. a surface facing in a direction toward a display panel, and a lower surface in the drawings.

In the present invention, the folding region of the display is a region of the display at which the display is folded in two or a region of the display at which the display is bent or rolled. Also, in the present invention, a folding region of the flexible cover window corresponding to the folding region of the display is referred to as a “folding portion” of the flexible cover window, and a planar region of the flexible cover window excluding the folding portion is referred to as a “planar portion” of the flexible cover window.

In particular, the flexible cover window according to the present invention is a glass-based flexible cover window, and a chemically strengthened glass substrate 100 is used.

The glass substrate 100 according to the present invention may be entirely flat (the thicknesses of the folding portion and the planar portion are equal to each other), or the folding portion may be divided into two or more pieces, whereby the glass substrate 100 may have a two-piece or three-piece structure.

In addition, the folding portion may be formed so as to have a smaller thickness than the planar portion, i.e.

the folding portion may be formed so as to be slimmer than the planar portion. In general, the thickness of the planar portion of the flexible cover window is 30 to 300 μm, and the thickness of the folding portion of the flexible cover window is about 10 to 100 μm. That is, a very thin sheet of glass is processed to form the folding portion. Here, the folding portion may be formed so as to have a uniform thickness, or may be formed so as to have a thickness gradually increasing from the middle to the edge of the folding region. That is, the folding portion may be formed in a straight line or a curved line.

In addition, an etched pattern may be formed in the folding portion and the planar portion or only in the folding portion in order to improve strength and folding characteristics of the glass substrate 100.

The flexible cover window according to the present invention is formed over the entire surface of the flexible display panel in order to protect the flexible display panel. Alternatively, the flexible cover window may also be disposed on a clear polyimide (CPI) cover in order to protect the CPI cover.

As one embodiment of the present invention, as shown in FIG. 1, the flexible cover window with improved strength according to the present invention includes a glass substrate 100 and a polyimide (PI) coating layer 200 formed on a front surface of the glass substrate 100, wherein a functional layer 300 is formed on the PI coating layer 200.

The PI coating layer 200 may be formed on one surface or opposite surfaces of the glass substrate 100. As a result, surface hardness of the flexible cover window is improved, folding characteristics of the flexible cover window are improved, and the force of shock applied to the flexible cover window is uniformly dispersed. In particular, shock force, such as pen drop, is dispersed or absorbed.

Generally, in the case in which the flexible cover window is manufactured using a glass material, the thickness of the glass substrate 100 must be small. In order to secure strength characteristics, however, the glass substrate 100 must have a specific thickness or more.

For example, in the case in which the radius of curvature at the time of folding must satisfy a minimum of 0.5 mm, the flexible cover window may have a thickness of 200 μm or less, preferably 20 to 100 μm. As the thickness of the flexible cover window is decreased, the strength of the flexible cover window is also decreased. Particular, in the case in which an object having a small sectional area collides with the upper surface (the front surface) of the glass substrate 100, i.e. when pen drop occurs, the entire glass substrate 100 may be deformed or damaged around a pen-drop contact portion thereof.

In particular, for a flexible cover window having a slimmed folding region, the thickness of the folding region is particularly small, whereby pen-drop resistance characteristics thereof are very weak. In addition, a stress difference occurs due to a thickness difference between the folding region and each of the planar regions, whereby a waviness problem of the glass substrate 100 also occurs. As a result, shock resistance of the flexible cover window is very low.

In the present invention, the PI coating layer 200 is entirely formed on one surface or opposite surfaces of the glass substrate 100 in order to improve shock resistance through improvement in the pen-drop resistance characteristics at the folding portion and at the same time to improve folding characteristics while improving overall strength of the glass substrate 100.

In particular, the thickness or the physical properties of the PI coating layer 200 are adjusted and the PI coating layer 200 is formed on the glass substrate 100 by direct coating in order to disperse or absorb shock force without necessity to perform troublesome work, such as a masking process or an etching process, such that a specific pattern or folding portion is formed on the glass substrate 100 in order to improve strength characteristics and folding characteristics, as in the conventional art, and therefore process simplification is achieved.

The PI coating layer 200 is formed on the glass substrate 100 by any one of bar coating, slot-die coating, and dip coating, and is UV-hardened after coating.

In one embodiment of the present invention, a coating solution including PI is applied to the glass substrate 100, and is UV-hardened at 200° C. to 300° C. for about one hour to form the PI coating layer 200.

The PI coating layer 200 according to the present invention is formed by coating the glass substrate 100 with a coating solution including 100 parts by weight of polyimide (PI) and 2 to 10 parts by weight of primer. That is, a solvent-free coating solution is used in order to prevent a problem in that the glass substrate 100 is stained or thickness uniformity of the glass substrate 100 is deteriorated at the time of hardening.

A silane coupling agent, which improves coupling in an undiluted PI solution, is used as the primer. For example, a silane coupling agent having a reactive group, such as an ethoxy group, a methoxy group, a dialkoxy group, or a trialkoxy group, may be used.

In order to increase the force of adhesion to the glass substrate 100, as described above, PI is mixed with the primer, and the mixture is applied to the glass substrate 100 by direct coating and is hardened to form the PI coating layer 200. Consequently, tight contact between the PI coating layer 200 and the glass substrate 100 is excellent, whereby deformation of the flexible cover window at the interface thereof is minimized even due to shock, such as pen drop, while overall durability of the flexible cover window is improved.

Generally, in the case in which shock, such as pen drop, is applied to the flexible cover window, shock that is transmitted vertically is stronger than shock that is transmitted horizontally. The PI coating layer 200 according to the present invention is formed over the entire surface of the glass substrate 100. Consequently, it is possible to efficiently disperse or absorb vertical shock and to support the glass substrate 100, whereby it is possible to remarkably improve pen-drop resistance characteristics.

For a conventional flexible cover window, a separate protective film is additionally applied to the glass substrate 100 in order to reinforce low pen-drop resistance characteristics. In the flexible cover window according to the present invention, however, the PI coating layer 200 is formed on the glass substrate 100 by direct coating, whereby inherent texture of glass is maintained while the overall thickness of the flexible cover window is reduced, and therefore aesthetics of the flexible cover window are improved.

Also, in the present invention, the functional layer 300 may be formed on the PI coating layer 200 formed on the front surface of the glass substrate 100.

Since the front surface of the flexible cover window is touched, the functional layer 300 may be implemented by a surface protective layer with further reinforced strength. In the case in which the functional layer 300 is used as a surface protective layer, a material including a high content of a resin having relatively high hardness when hardened, such as acrylic or epoxy, may be used.

In addition, an anti-fingerprint (AF) or anti-reflective (AR) function may be imparted to the functional layer 300 as needed. Resins having such a function may be combined, or various patterns, such as a moth-eye pattern, may be formed at the functional layer 300 to realize the function.

An adhesive layer is formed on a back surface of the flexible cover window, i.e. a back surface of the glass substrate or a back surface of the PI coating layer, so as to be adhered to the flexible display panel. The adhesive layer may be formed so as to have an optically clear adhesive (OCA) structure or an OCA/support film layer/OCA structure.

Here, at least one of polyethylene terephthalate (PET), polypropylene (PP), polyethylene naphthalate (PEN), and polycarbonate (PC) may be used as the support film layer, and the support film layer may have a plurality of layers formed through the medium of an OCA.

In the case in which the adhesive layer is constituted by a single OCA layer, the thickness of the adhesive layer may be about 10 μm to 50 μm. In the case in which the adhesive layer is formed so as to have an OCA/support film layer/OCA structure, the upper OCA may be formed so as to have a thickness of 10 μm to 50 μm, the support film layer may be formed so as to have a thickness of 10 μm to 50 μm (haze of 3.0 or less), and the lower OCA may be formed so as to have a thickness of 10 μm to 75 μm.

In the case in which the adhesive layer is formed on the back surface of the glass substrate so as to have an OCA/support film layer/OCA structure, it is possible to absorb microscopic deformation due to the difference in elongation between the glass substrate and the display panel, whereby it is possible to prevent delamination or buckling at the folding portion, and therefore it is possible to improve lifespan of the flexible cover window and to minimize distortion of an image at the folding portion.

An upper surface of the adhesive layer is covered with a cover film, and the cover film is removed such that the adhesive layer is adhered to a surface of the display panel. At this time, in order to minimize capture of air bubbles between the display panel and the flexible cover window (the adhesive layer), it is preferable to spray water to the surface of the display panel and to laminate the display panel and the flexible cover window.

In embodiments of the present invention, as shown in FIGS. 1 to 6, the PI coating layer 200 is formed on the front surface of the glass substrate 100 (the upper surface of the glass substrate 100 in the drawings).

FIG. 1 shows that the PI coating layer 200 is formed on the front surface of the glass substrate 100 and the functional layer 300 is formed on the PI coating layer 200. Shock applied to the front surface (the touch surface) of the glass substrate 100 is dispersed or absorbed by the PI coating layer 200. In addition, the PI coating layer 200 is formed over the entire surface of the glass substrate 100 in order to support the glass substrate 100.

In another embodiment of the present invention, as shown in FIG. 2, the PI coating layer 200 may be formed on opposite surfaces, i.e. the front surface and the back surface, of the glass substrate 100. Shock is primarily absorbed by the PI coating layer 200 formed on the front surface of the glass substrate 100, which is a surface including the contact portion to which shock is applied, and shock transmitted to the interior of the glass substrate 100 is absorbed by the PI coating layer 200 formed on the back surface of the glass substrate 100.

Here, the PI coating layer 200 formed on the front surface of the glass substrate 100 and the PI coating layer 200 formed on the back surface of the glass substrate 100 may be made of different materials while having different strengths and thicknesses.

Also, in the present invention, the PI coating layer 200 may be formed so as to have a thickness of 1 to 50 μm, which is a thickness required to efficiently absorb or disperse shock in consideration of the overall thickness and folding characteristics of the flexible cover window.

If the thickness of the PI coating layer 200 is less than the above thickness range, a shock dispersion effect may be insignificant. If the thickness of the PI coating layer 200 is greater than the above thickness range, the thickness of the flexible cover window may be increased, and therefore folding characteristics of the flexible cover window may be deteriorated.

In the case in which the PI coating layer 200 is formed over the entire surface of the glass substrate 100, as described above, vertical shock, such as pen drop, is supported or dispersed, whereby pen-drop resistance characteristics, folding characteristics, and the overall strength characteristics of the flexible cover window are improved.

In another embodiment of the present invention, as shown in FIG. 3, the PI coating layer 200 may be formed on a side surface of the glass substrate 100 as well as the front surface and the back surface of the glass substrate 100 so as to wrap the glass substrate 100. That is, the PI coating layer 200 is formed so as to extend from the front surface and the back surface of the glass substrate 100 to the side surface of the glass substrate 100.

As a result, the overall region of the glass substrate 100 is wrapped by the PI coating layer 200, whereby the strength of the glass substrate 100 is improved while dispersion of the glass substrate 100 is prevented.

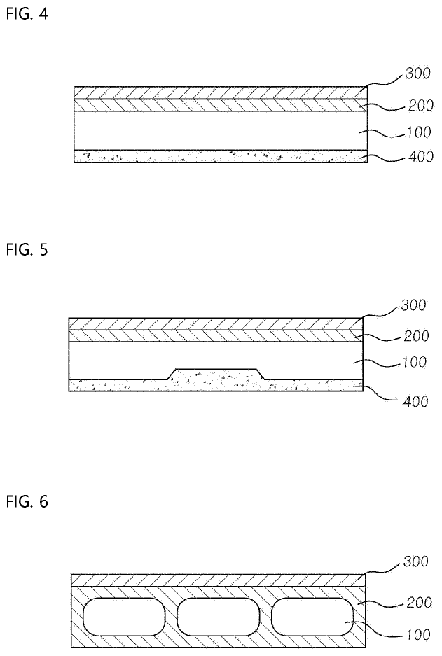

In another embodiment of the present invention, as shown in FIG. 4, a buffer layer 400 may be further formed between the back surface of the PI coating layer 200 and the flexible display panel.

The buffer layer 400 reinforces shock resistance of the glass substrate 100 while preventing dispersion of the glass substrate 100. To this end, the buffer layer 400 is formed so as to have a thickness of 1 to 40 μm.

A transparent resin having almost the same refractive index as glass (having a refractive index of 1.5), such as an optically clear resin (OCR), may be used as the buffer layer 400. For example, acrylic, epoxy, silicone, urethane, a urethane composite, a urethane acrylic composite, a sol-gel hybrid material, or a siloxane-based material may be used.

The PI coating layer 200 according to the present invention is made of a material different from the material for the buffer layer 400 such that the strength of the PI coating layer 200 is different from the strength of the buffer layer 400, whereby it is possible to efficiently disperse or absorb shock applied to the glass substrate 100 and to stably support the glass substrate 100.

In addition, the PI coating layer 200 is made of a material configured such that the PI coating layer 200 has equal strength or different strengths at the planar portion and the folding portion, whereby the strength characteristics and the folding characteristics of the flexible cover window are reinforced depending on the specifications of products in various environments.

In another embodiment of the present invention, as shown in FIG. 5, the folding portion of the glass substrate 100 is formed so as to be slimmer than the planar portion of the glass substrate 100, the PI coating layer 200 is formed on the glass substrate 100, and the functional layer 300 is formed on the PI coating layer 200. As a result, the folding characteristics of the flexible cover window as well as the strength characteristics of the flexible cover window are further improved.

In FIG. 5, the slimmed folding portion is formed so as to be located at the back surface of the glass substrate 100. The slimmed folding portion may be formed the front surface, the rear surface, or the opposite surfaces of the glass substrate 100 depending on the specifications of products.

In a further embodiment of the present invention, as shown in FIG. 6, the folding portion of the glass substrate 100 is divided into two or more pieces, whereby the glass substrate 100 has a three-piece structure. The PI coating layer 200 is formed so as to wrap the divided glass substrate 100. As a result, the folding characteristics of the flexible cover window as well as the strength characteristics of the flexible cover window are further improved.

In the present invention, as described above, the PI coating layer 200 is formed on the glass substrate 100, whereby shock, such as pen drop, is further dispersed or absorbed, and therefore shock resistance is further improved.

In addition, the thickness and the physical properties of the PI coating layer 200 according to the present invention are appropriately adjusted, whereby it is possible to minimize the occurrence of cracks at the folding portion depending on the specifications of products, and the PI coating layer 200 is uniformly formed on the entirety of the glass substrate 100, whereby it is possible to secure flatness of the portion of the flexible cover window that abuts the display panel.

In addition, elastic force of the flexible cover window at the surface of the flexible cover window that abuts the display panel is reinforced by the buffer layer 400 according to the present invention, whereby shock resistance of the flexible cover window is improved, and it is possible to prevent dispersion of the glass substrate 100 when the glass substrate 100 is broken.

Also, in the present invention, the flexible cover window is made of a composite material including glass and a resin material, whereby flexibility, restoring force, elastic force, and strength characteristics of the flexible cover window are reinforced by the resin material while texture of the glass is maximally maintained.

Table 1 below shows data on pen-drop resistance characteristics and measured hardness of a flexible cover window according to an example of the present invention and flexible cover windows according to comparative examples.

TABLE 1

| | Pen-drop resistance | Measured |
|---|---|---|
| | characteristics | hardness |
| Comparative | 1 cm to 2 cm | 4H |
| Example 1 (Bare) | | |
| Comparative | 2 cm to 3 cm | 3H |
| Example 2 | | |
| Comparative | 10 cm | B |
| Example 3 | | |
| Example | 10 cm or more | 3H |

In Comparative Example 1, a glass substrate (bare) having a thickness of 30 μm was used. In Comparative Example 2, a hard coating layer having a thickness of about 2 μm was formed on a glass substrate having a thickness of 30 μm. In Comparative Example 3, a protective film, such as CPI or TPU, was formed on a glass substrate having a thickness of 30 μm.

In the example of the present invention, a PI coating layer having a thickness of 2 μm (a weight ratio of PI to primer being 100:5) was formed on a glass substrate having a thickness of 30 μm.

As shown in Table 1 above, it can be seen that, for the example of the present invention, pen-drop resistance characteristics, 10 cm or more, were remarkably improved, and hardness, 3H or more, was improved.

In the flexible cover window according to the present invention, as described above, the PI coating layer is formed on the glass substrate, whereby strength characteristics of the flexible cover window are improved and inherent texture of glass is maintained while the overall thickness of the flexible cover window is reduced, and therefore aesthetics of the flexible cover window are improved.

As is apparent from the above description, the present invention relates to a flexible cover window, and more particularly to a flexible cover window configured such that a PI coating layer is formed on a glass substrate, whereby surface hardness, pen-drop resistance characteristics, and folding characteristics of the flexible cover window are improved.

For a conventional flexible cover window, a separate protective film is additionally applied to the glass substrate in order to reinforce low pen-drop resistance characteristics. In the flexible cover window according to the present invention, however, the PI coating layer is formed on the glass substrate by direct coating, whereby inherent texture of glass is maintained while the overall thickness of the flexible cover window is reduced, and therefore aesthetics of the flexible cover window are improved.

Also, in the present invention, in order to increase the force of adhesion to the glass substrate, PI is mixed with primer, and the mixture is applied to the glass substrate by direct coating and is hardened to form the PI coating layer. Consequently, tight contact between the PI coating layer and the glass substrate is excellent, whereby deformation of the flexible cover window at the interface thereof is minimized even due to shock, such as pen drop, while overall durability of the flexible cover window is improved.

In addition, the flexible cover window according to the present invention is implemented using a combination of glass and a resin material, whereby flexibility, restoring force, elastic force, and strength characteristics are reinforced by the resin material while texture of the glass is maximally maintained. In particular, the resin material absorbs shock, such as pen drop, whereby shock resistance is further improved.

Although the present invention has been described in detail based on concrete embodiments, those skilled in the art will appreciate that the present invention is not limited thereto and that various modifications, additions, and substitutions are possible without departing from the scope and spirit of the invention as disclosed in the accompanying claims.

1. A glass-based flexible cover window with improved strength comprising a planar portion formed so as to correspond to a planar region of a flexible display and a folding portion formed so as to be connected to the planar portion, the folding portion being formed so as to correspond to a folding region of the flexible display, wherein the flexible cover window comprises:
a glass substrate; and
a polyimide (PI) coating layer formed on the glass substrate.

2. The flexible cover window according to claim 1, wherein the PI coating layer is formed on one surface or opposite surfaces of the glass substrate.

3. The flexible cover window according to claim 1, wherein the PI coating layer has a thickness of 1 to 50 μm.

4. The flexible cover window according to claim 1, wherein the PI coating layer is formed by coating the glass substrate with a coating solution comprising 100 parts by weight of polyimide (PI) and 2 to 10 parts by weight of primer.

5. The flexible cover window according to claim 1, wherein the PI coating layer is formed on a front surface, a back surface, and a side surface of the glass substrate so as to wrap the glass substrate.

6. The flexible cover window according to claim 1, wherein the PI coating layer is formed on the glass substrate by coating and is then UV-hardened.

7. The flexible cover window according to claim 6, wherein the PI coating layer is formed on the glass substrate by any one of bar coating, slot-die coating, and dip coating.

8. The flexible cover window according to claim 1, further comprising a functional layer formed on the PI coating layer formed on a front surface of the glass substrate.

9. The flexible cover window according to claim 1, further comprising a buffer layer formed between a back surface of the glass substrate and a display panel.

10. The flexible cover window according to claim 1, wherein the PI coating layer is made of a material configured such that the PI coating layer has an equal strength or different strengths at the planar portion and the folding portion.

11. The flexible cover window according to claim 1, wherein the glass substrate is integrally formed.

12. The flexible cover window according to claim 11, wherein the glass substrate is formed such that the folding portion is slimmer than the planar portion.

13. The flexible cover window according to claim 1, wherein the glass substrate is formed such that the folding portion is divided into two or more pieces.

14. The flexible cover window according to claim 2, wherein the glass substrate is integrally formed.

15. The flexible cover window according to claim 14, wherein the glass substrate is formed such that the folding portion is slimmer than the planar portion.

16. The flexible cover window according to claim 3, wherein the glass substrate is integrally formed.

17. The flexible cover window according to claim 16, wherein the glass substrate is formed such that the folding portion is slimmer than the planar portion.

18. The flexible cover window according to claim 2, wherein the glass substrate is formed such that the folding portion is divided into two or more pieces.

19. The flexible cover window according to claim 3, wherein the glass substrate is formed such that the folding portion is divided into two or more pieces.

20. The flexible cover window according to claim 4, wherein the glass substrate is formed such that the folding portion is divided into two or more pieces.
